(19) United States
(12) Patent Application Publication
(10) Pub. No.: US 2006/0106325 A1
(43) Pub. Date: May 18, 2006

(54) Ultrasonic medical device

(76) Inventor: John Perrier, Bulimba (AU)

Correspondence Address: HOFFMAN WASSON & GITLER, P.C;CRYSTAL CENTER 2, SUITE 522, 2461 SOUTH CLARK STREET, ARLINGTON, VA, 22202-3843, US

(21) Appl. No.: 10/532,210

(22) PCT Filed: Oct. 16, 2003
(86) PCT No.: PCT/AU03/01359

§ 371 Date: Apr. 22, 2005

(30) Foreign Application Priority Data
Oct. 28, 2002 (AU) 2002952526
Dec. 18, 2002 (AU) 2002953557

(51) Int. Cl. A61H 1/00

(52) U.S. Cl. 601/2

(57) ABSTRACT

Ultrasonic medical apparatus (10) is disclosed comprising ultrasonic transducers (16) and associated electronics incorporated in a portable hand-held device (10) adapted for engagement with the neck of a person and energised to induce a coughing reflex in the person. The apparatus can be utilised on subjects who, for various reasons, are unable to initiate coughing themselves at the time, and results in the effective clearing of fluid and debris within small airways in the lungs which cannot be reached by intrusive suction clearing.

### FIELD OF THE INVENTION

This invention relates to medical apparatus for the induction of reflexive responses in a patient. It has particular but not exclusive application to inducing a coughing reflex in human patients, and for illustrative purposes, reference will be made to such application. However, it is to be understood that the apparatus may be used in other applications, such as inducing other reflexive responses and/or similar responses in animals.

### BACKGROUND OF THE INVENTION

It is generally accepted in medical circles that the coughing reflex is a vital part of maintaining normal lung function, as it acts to rid the lungs of excessive secretions such as mucus or inhaled substances. Under some circumstances, patients are unable to cough on demand, rendering them liable to the exacerbation or prolongation of respiratory problems.

Those patients who are unable to cough on demand include the very young, gravely ill and incapacitated patients, patients who have undergone a near-drowning experience or overdosed on drugs of a type which suppresses the responses of the central nervous system, unconscious or heavily-sedated patients, victims of stroke, elderly patients who have lost control of their bodily functions, intubated patients with temporary airways and patients who are anaesthetised during or following surgery.

Currently, the method of clearing mucus from the upper respiratory tract or to induce a coughing reflex is through the introduction through intubation of the upper airway, using vacuum drainage or pulmonary lavage catheters. Unfortunately, this method is inefficient in clearing secretions from the lower respiratory airways, as it lacks the explosive clearing mechanism associated with a coughing spasm. In addition, while the larger airways may be cleared by suction, the smaller airways, such as the bronchioles are too small to be cleared efficiently by suction.

Each year, tens of thousands of people die from respiratory problems. Foremost among these deaths are sufferers of the following conditions:—
respiratory illness;
bronchitis (acute and chronic);
pneumonia;
chest infections (bacterial and microbial);
paediatric respiratory problems;
cystic fibrosis;
bronchiolitis (a paediatric form of bronchitis);
burns injuries;
drowning, and
self-aspiration, such as following a drug or alcohol overdose.

Many of these patients die because their lungs fill with excessive levels of secretions or other fluids. The usual method of self-clearing the lungs is to cough. However, many people, for one reason or another, are unable to cough when necessary, rendering them vulnerable to the prolongation of respiratory problems.

Even in a hospital environment, the methods used for clearing the lungs are often ineffective. Typically, a suction catheter is used to draw the fluids out of the lungs, but this often only clears the upper airways, as' the catheter used cannot penetrate to the lower airways, which are most prone to consequences of pneumonia and chest infections. In addition, a suction catheter is not readily utilised outside a hospital as it requires infrastructure to operate.

Thus it is apparent that the only fully effective way to clear the lower airways is by coughing. Over the years, medical staff have experimented with a number of techniques to stimulate the coughing reflex Such methods have included applying manual pressure to the front of the neck, blowing dry oxygen down the throat, and tickling the back of the palate. None of these methods has proved effective on a consistent basis. If the smallest airways remain blocked, respiration can be compromised to the extent that the respiratory centre is depressed through hypoxia and the patient dies from asphyxiation. The coughing reflex is therefore a natural and highly-effective mechanism whereby air is expelled under force to clear the pulmonary system, starting in the smallest airways and proceeding to the trachea.

### OBJECT OF THE PRESENT INVENTION

It is the object of the present invention to overcome the limitations imposed by the prior art by providing a means for stimulating the natural reflex.

### STATEMENT OF THE INVENTION

With the foregoing and other objects in view, this invention in one aspect resides in apparatus for inducing a coughing reflex in a person or animal, said apparatus including:—

ultrasonic wave generation means for producing ultrasonic vibrations of a frequency suitable for at-least limited penetration of soft body tissue, whereby application of said generation means to a suitable contact region on the body of the person may stimulate a reflexive response. Suitably, the contact region is a selected portion of the neck (pharynx) of the person and the reflexive response is coughing, although other reflexive responses, such as the contraction of other muscles, may also be achieved by contact with an appropriate region of the body.

Suitably, the ultrasonic wave generation means includes an ultrasonic transducer adapted for producing mechanical vibrations in response to vibratory electrical input from an electrical oscillator. However, if desired, other generating means, such as fluidics transducers and oscillators, which function by producing pressure oscillations in a gas, may be used.

A single ultrasonic transducer may be utilised. However it is preferred that a transducer array of at least two transducers be provided and that the transducers forming said array are held in positions and orientations which maximise contact with the region known to stimulate the desired response. In order to enhance such contact, the transducers may be mounted flexibly relative to one another, being disposed along a flexible mount and/or being attached to a mount through flexible mountings. Adjustment means may be provided between transducers and the mount whereby the position of the transducers relative to one another may be optimised to suit a particular neck.

The transducer array may be mounted to a handle, and the handle may contain all or part of the electronic circuitry required to power the transducer array. The transducer array may be attached detachably to the handle, and a plurality of arrays may be provided for interchange, the arrays differing in size and/or array pattern to accommodate necks of differing size or shape. It is envisaged that much smaller arrays than normal may be required for paediatric applications.

The effective transfer of ultrasonic vibration into the neck is dependent on achieving good contact between the neck and the active faces of the transducers. In order to ensure that this is achieved, contact sensing means may be provided for determining the quality of the contact between said transducers and a neck, and contact indicating means for indicating when good contact has been made. Suitably, this may be achieved with electronic circuitry adapted to drive the transducers at a low power level while sensing the damping of the oscillations which occurs when in good contact with the neck, and illuminating a light when good contact is achieved. If desired, individual lights may be provided for each transducer, allowing a user greater feedback for applying the apparatus correctly.

In a further aspect, this invention resides in a method of inducing a reflexive response in a person or animal, including:—
providing ultrasonic wave generation means for producing ultrasonic vibrations of a frequency suitable for at-least limited penetration of soft body tissue, and
applying the active portion of said wave generation means to a selected portion of the body of a person or animal, whereby a desired reflexive response may be achieved.

### BRIEF DESCRIPTION OF THE DRAWINGS

In order that the invention to be more readily understood and put into practical effect, reference will now be made to the accompanying diagrams, which illustrate a preferred embodiment of the invention, wherein:—

FIG. 1 is a perspective view of a coughing-reflex inducer apparatus according to the invention;

FIG. 2 is a top view of the apparatus shown in FIG. 1;

FIG. 3 is a side view of the apparatus shown in FIG. 1;

### DETAILED DESCRIPTION OF THE DRAWINGS

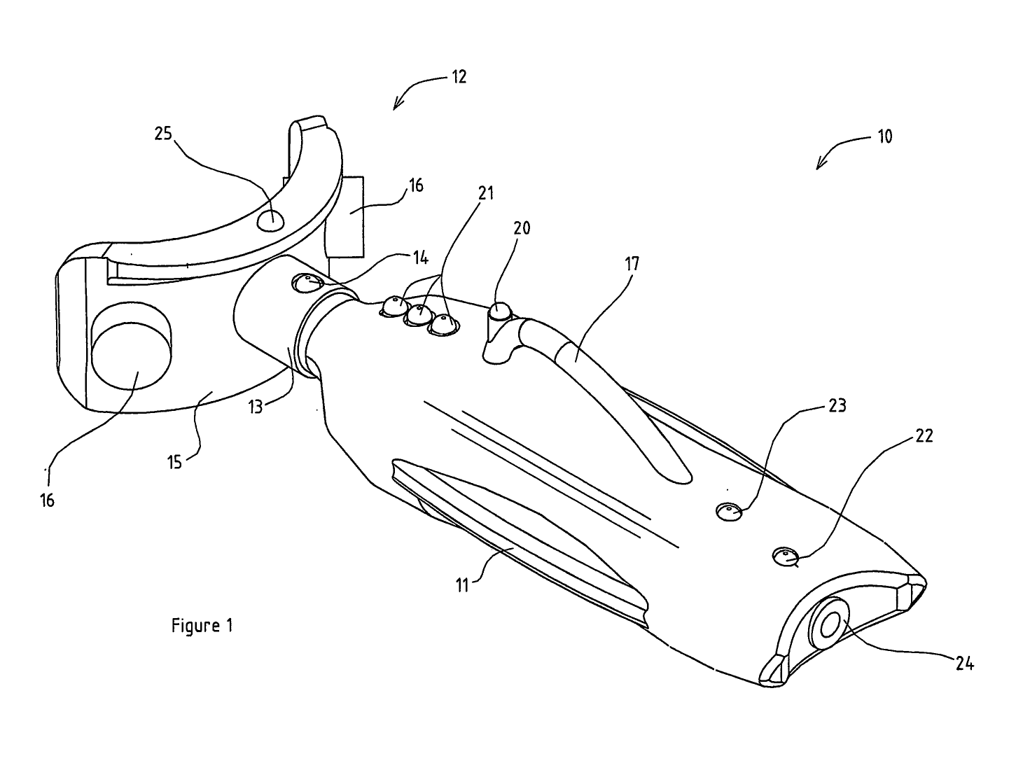

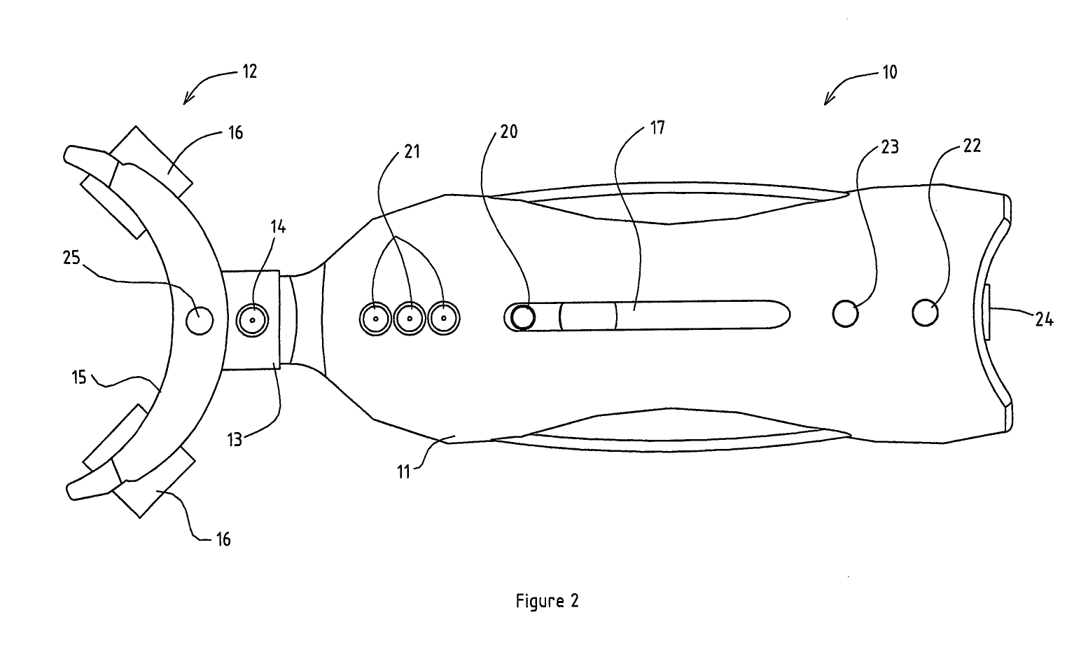

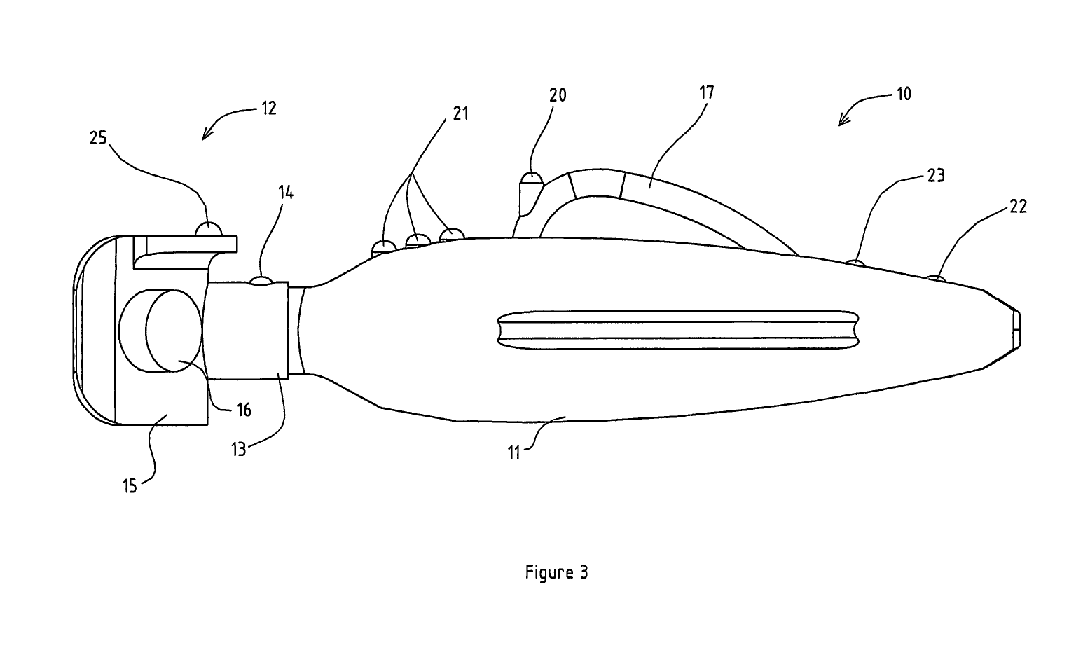

The coughing-reflex inducer 10 shown in FIGS. 1, 2 and 3 includes a body 11 to which is attached an applicator assembly 12 through a snap-on/off joint 13 which is locked by a detent button 14. The applicator assembly 12 includes an arcuate transducer support 15 holding a pair of ultrasonic transducers 16. The body 11 encloses a power electronic oscillator, batteries and timing equipment (not shown). The body 11 may be supported on a handle 17 which carries a two-stage actuation switch 20. A group of push-buttons 21 is provided for pre-setting treatment options such as intensity and duration of the ultrasonic treatment. A battery-indicator light 22 is provided to indicate the energy level of the battery, and a “power-on” indicator light 23 is provided which is illuminated whenever the apparatus is in operation. A charging socket 24 is provided for charging the internal rechargeable batteries (not shown). A “contact quality” light 25 is provided on the support 15 to indicate when the transducers 16 are in effective contact with the neck.

In use, the inducer 10 is held by the handle 17 by the practitioner and presented to the neck of a patient with the surfaces of the transducers 16 in contact with the neck. If a good fit to the shape of the neck cannot be obtained, the applicator assembly 12 is detached from the body 11 at the joint 13 and another applicator assembly 12 with different geometry is attached. The practitioner makes appropriate adjustments to the settings of the push-buttons 21, then presses the first stage of the actuation switch 20. This initiates low-powered ultrasonic emanations from the transducers 16, and if the degree of damping measured by the electronic circuitry is sufficient to indicate good contact between the transducers 16 and the neck, the light 25 illuminates. If the light 25 does not illuminate, the practitioner must re-align the transducers with the neck until it does. The practitioner can then press the second stage of the actuation switch 20, and higher-power ultrasonic waves generated by the apparatus penetrate the neck tissues, and the vibrations excite the hair-like structures known as cilia which line the pharynx. It is believed that this excitation simulates the effect on the cilia of ingested dust or debris, and the coughing reflex is induced as if to clear such dust or debris. The low power levels required relative to known established external therapeutic ultrasonic treatments indicate that side effects are likely to be minimal.

It will of course be realised that, while the foregoing has been given by way of illustrative example of the invention, all such and other modifications and variations thereto as would be apparent to persons skilled in the art are deemed to fall within the broad scope and ambit of the invention.

1-10. (canceled)

11. Apparatus for inducing a coughing reflex in a person or animal, said apparatus including at least one ultrasonic transducer adapted to be placed in contact with a region of the neck of the person or animal, and ultrasonic wave generation means for producing ultrasonic vibrations in said transducer of a frequency suitable for at least limited penetration of soft body tissue whereby to stimulate a reflexive coughing response in said person or animal.

12. Apparatus as claimed in claim 11 wherein said ultrasonic wave generation means comprises an electrical oscillator and wherein said at least one transducer is adapted to produce mechanical vibrations in response to an electrical input from said oscillator.

13. Apparatus as claimed in claim 11 and including a transducer array of at least two separate said transducers, said transducers in said array being held in positions and orientations which maximise contact with said neck region.

14. Apparatus as claimed in claim 13 and including a support for said transducers, said transducers being spaced along said support

15. Apparatus as claimed in claim 14 wherein said support comprises a flexible mount whereby said transducers are flexibly mounted relative to one another.

16. Apparatus as claimed in claim 14 wherein said transducers are mounted to said support by flexible mounting means whereby said transducers are flexibly mounted relative to one another.

17. Apparatus as claimed in claim 14 and including adjustment means between said transducers and said support whereby the position of the transducers relative to one another may be adjusted to suit a particular neck.

18. Apparatus as claimed in claim 14 and including a main body housing said ultrasonic generation means, said support being mounted to said main body.

19. Apparatus as claimed in claim 18 and including an applicator assembly including said support and said transducers, said applicator assembly being detachably mounted to said main body.

20. Apparatus as claimed in claim 18 wherein said support comprises an arcuate member and wherein said transducers comprise a pair of transducers arranged at spaced apart positions along said member.

21. Apparatus as claimed in claim 1 and including contact sensing means for determining the quality of the contact between said at least one transducer and said neck, and contact indicating means for indicating when good contact has been made.

22. A method of inducing a reflexive coughing response in a person or animal, said method including the steps of providing ultrasonic wave generation means for producing ultrasonic vibrations of a frequency suitable for at least limited penetration of soft body tissue, said ultrasonic wave generation means having an active portion, and applying the active portion of said wave generation means to a selected region of the neck of a person or animal, whereby a desired reflexive coughing response may be achieved.

23. Apparatus for inducing a coughing reflex in a person or animal, said apparatus including:
an elongated main body;
an applicator assembly comprising a transducer support mounted to one end of said main body, and
at least one ultrasonic transducer on said transducer support adapted to be placed in contact with a region of the neck of the person or animal; and
an ultrasonic wave generator in said main body and connected to said at least one ultrasonic transducer for producing ultrasonic vibrations in said at least one transducer of a frequency suitable for at least limited penetration of soft body tissue whereby to stimulate a reflexive coughing response in said person or animal.

24. Apparatus as claimed in claim 23 wherein said main body supports an actuation switch for actuating said ultrasonic wave generator.

25. Apparatus as claimed in claim 24 wherein said actuation switch comprises a two stage switch and wherein a first stage actuation of said switch causes low-powered ultrasonic waves to be emitted from said at least one transducer and wherein a second stage actuation of said switch causes higher-powered ultrasonic waves to be emitted by said at least one transducer.

26. Apparatus as claimed in claim 23 and including a contact quality indicator on said transducer support for indicating contact between said at least one transducer and said neck.

27. Apparatus as claimed in claim 23 wherein said transducer support carries a pair of ultrasonic transducers spaced apart along said support.

28. Apparatus as claimed in claim 27 wherein said transducer support comprises an arcuate member having a concave side and a convex side, said arcuate member having central attachment means on said convex side for mounting said member to said main body and wherein said transducers are arranged symmetrically on opposite sides of said attachment means.

29. Apparatus as claimed in claim 23 and including a holding handle on said main body.
